(19) United States
(12) Patent Application Publication
(10) Pub. No.: US 2017/0171613 A1
(43) Pub. Date: Jun. 15, 2017

(54) METHOD AND APPARATUS FOR CONTROLLING ELECTRONIC DEVICE, AND STORAGE MEDIUM

(71) Applicant: Xiaomi Inc., Beijing (CN)

(72) Inventors: Chao Xu, Beijing (CN); Kangxi Tan, Beijing (CN); Tongcai Xiu, Beijing (CN)

(73) Assignee: Xiaomi Inc., Beijing (CN)

(21) Appl. No.: 15/361,899

(22) Filed: Nov. 28, 2016

(30) Foreign Application Priority Data
Dec. 15, 2015 (CN) 201510938122.X

(51) Int. Cl. H04N 21/442; H04N 21/472; H04N 21/45; G06T 7/00; H04N 21/4363; H04N 21/4415; G06K 9/00; H04N 21/637; H04N 21/436

(52) U.S. Cl. CPC H04N 21/44218; H04N 21/637; H04N 21/47217; H04N 21/4524; H04N 21/43615; H04N 21/43637; H04N 21/4415; H04N 21/44227; G06K 9/00255; G06K 9/00288; G06T 7/004

(57) ABSTRACT

The present disclosure relates to a method and apparatus for controlling an electronic device, and a storage medium. A first electronic device to be watched by a user is determined according to a position of the user, playing information of a media file currently played by a second electronic device is determined. The playing information including an identifier of the media file and a playing progress of the media file, and first control information is sent to the first electronic device to control the first electronic device to play the media file from the playing progress The first control information including the playing information and screen activation control information.

### CROSS-REFERENCE TO RELATED APPLICATIONS

This application claims priority to Chinese Patent Application No. 201510938122.X, filed on Dec. 15, 2015, the entirety of which is hereby incorporated by reference herein.

### TECHNICAL FIELD

The present disclosure generally relates to a smart solution for handing off playback of media files amongst communication devices connected to a common network based on detected conditions that predict a user's location.

### BACKGROUND

With the development of communication technologies, personal communication devices such as smart televisions, tablet computers, smart phones, and notebook computers are being used with more frequency within a user's home environment.

When a user watches a video, pictures, or other digital media on a television in a living room, the user will have to restart the media file on another communication device if the user decides to move to another room in the house. The process of restarting the media file on the other communication device may involve many cumbersome steps such as turning on the communication device, locating the media file, locating a position within the media file the user last left off, and finally starting playback of the media file.

### SUMMARY

According to a first embodiment of the present disclosure, there is provided a method for controlling an electronic device, including: a first electronic device to be watched by a user is determined according to a position of the user; playing information of a media file currently played by a second electronic device is determined, herein the playing information may include: an identifier of the media file and a playing progress of the media file; and first control information is sent to the first electronic device to control the first electronic device to play the media file from the playing progress, herein the first control information includes: the playing information and screen turning-on control information.

According to a second embodiment of the present disclosure, there is provided an apparatus for controlling an electronic device, including: a processor; and a memory for storing instructions executable by the processor, wherein execution of the instructions by the processor causes the processor to: determine a first electronic device to be watched by a user according to a position of the user; determine playing information of a media file currently played by a second electronic device, wherein the playing information may include: an identifier of the media file and a playing progress of the media file; and send first control information to the first electronic device to control the first electronic device to play the media file from the playing progress, herein the first control information may include: the playing information and screen turning-on control information.

According to a third embodiment of the disclosure, there is provided a non-transitory computer-readable storage medium having stored therein instructions that, when executed by a processor, causes the processor to perform a method for controlling an electronic device, the method comprising: determining a first electronic device to be watched by a user according to a position of the user; determining playing information of a media file currently played by a second electronic device, wherein the playing information comprises: an identifier of the played media file and a playing progress of the media file; and sending first control information to the first electronic device to control the first electronic device to play the media file from the playing progress, wherein the first control information comprises: the playing information and screen turning-on control information.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of the present disclosure.

FIG. 1 is a flow chart showing a method for controlling an electronic device, according to an exemplary embodiment;

FIG. 2 is a flow chart showing a method for controlling an electronic device, according to another exemplary embodiment;

FIG. 3 is a flow chart showing a method for controlling an electronic device, according to another exemplary embodiment;

FIG. 4 is a block diagram of an apparatus for controlling an electronic device, according to an exemplary embodiment;

FIG. 5 is a block diagram of an apparatus for controlling an electronic device, according to another exemplary embodiment;

FIG. 6 is a block diagram of an apparatus for controlling an electronic device, according to another exemplary embodiment;

FIG. 7 is a block diagram of an apparatus for controlling an electronic device, according to another exemplary embodiment;

FIG. 8 is a block diagram of an apparatus for controlling an electronic device, according to an exemplary embodiment; and

FIG. 9 is a block diagram of an apparatus for controlling an electronic device, according to an exemplary embodiment.

The drawings have shown clear embodiments of the present disclosure, and more detailed descriptions will be made hereinafter. These drawings and textual descriptions are intended not to limit the scope of concept of the present disclosure in any manner but to describe the concept of the present disclosure for those skilled in the art with reference to specific embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

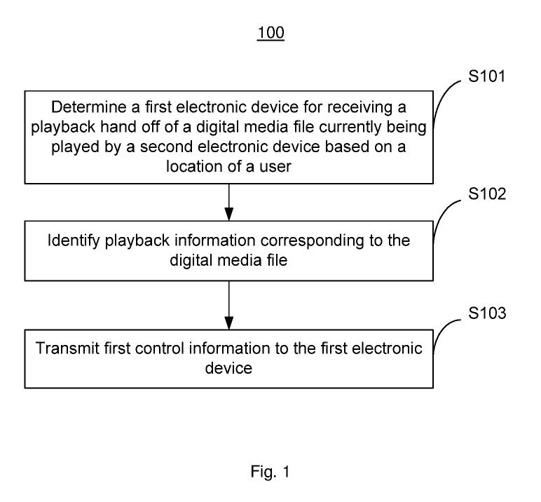

FIG. 1 shows a flow chart 100 of logic describing a process for controlling an electronic device, according to an exemplary embodiment. As shown in FIG. 1, the method for controlling an electronic device provided by the embodiment includes the following steps. The process described by flow chart 100 may be initiated in the context of a second electronic device currently executing playback of a media file within a known environment (for example, a user's house) where multiple electronic devices are located within. The process for controlling electronic devices described by flow chart 100 may also be understood to be implemented within the known environment where the multiple electronic devices are connected to, and communicate through, a common network. The media file may, for example, be a digital media file including digital audio, digital video, and/or digital images.

Each electronic device described herein may be a communication device including the capability to execute playback of a media file (e.g., digital video file playing function). Exemplary electronic device include, for example, a television, a notebook computer, a tablet or a mobile phone. The electronic devices that are connected to the common network may be controlled by a separate control center device such as a remote server. In addition or alternatively, any one or more of the multiple electronic devices may be operated as the control center device to control the multiple electronic devices as described herein. An control center device hereinafter could refer to a separate control center device such as a remote server or at least one of the multiple electronic devices. When the at least one of the multiple electronic devices are operated as the control center device, the multiple electronic devices could communicate through a common network that is setup according to Wi-Fi (wireless local area network products that are based on the Institute of Electrical and Electronic Engineers' (IEEE) 802.11 standards), a ZigBee protocol, a Bluetooth communication protocol, or the like.

Step S101: the control center device determines a first electronic device within the known environment to be the next electronic device to execute playback of the media file currently being played on the second electronic device. The control center device selects the first electronic device for the hand-off of playback responsibilities of the media file based on a determined location of the user.

In particular, determining the first electronic device based on the user's location may be based on facial recognition techniques that recognize facial images captured by the plurality of electronic devices within the known environment and compare the captured facial images to a pre-stored image of the user referenced by the control center device. The control center device may receive the captured facial images and determine the first electronic device that has captured the facial image that matches the pre-stored image of the user, thus indicating the user is positioned in front of the first electronic device. Other user locating solutions may also be utilized by the control center device to determine the first electronic device based on the location of the user at step S101.

Step S102: playback information of the media file currently played by the second electronic device is determined by the control center device.

Herein, the playback information may include: an identifier of the media file and a progress information describing a playback state of the media file.

As described, the second electronic device is an electronic device which is executing playback of the media file before the hand-off to the first electronic device. In an implementation mode, the control center device may query a stored playlist to identify the second electronic device and send a playback information acquisition request to the second electronic device, the second electronic device may then receive the request and send the playback information to the control center device, and in this way the control center device may receive the playback information of the media file from the second electronic device.

The identifier of the media file in the playback information may include information such as a name and a link of the media file. The media file here may be a video media file, a picture media file, or the like.

Step S103: the control center device may transmit a first control information to the first electronic device to control the first electronic device to execute playing of the media file from the playback state identified by the progress information in the playback information.

Herein, the first control information may include: the playback information and screen turning-on control information.

After receiving the playback information of the media file currently played by the second electronic device, the control center device may send the first control information to the first electronic device to control the first electronic device to turn on a display screen and play the media file from the playback state identified by the progress information in the playback information.

The media file may be an online video, and may also be a local video. When the media file is an online video, the identifier of the media file may include a media filename and a source link of the media file, so that the first electronic device may acquire the media file from the source link according to the identifier of the media file in the first control information and play the media file from the playback progress after receiving the first control information. When the media file is a local video, the identifier of the media file may include a media filename and an identifier of the second electronic device, so that the first electronic device may acquire the media file from the second electronic device according to the identifier of the second electronic device and play the media file from the playback progress after receiving the first control information.

According to the processes for controlling an electronic device described by the flow chart 100, a user's experience viewing the media file as the user moves to different locations and uses different electronic devices may be improved, compared with a manner of manually turning on the electronic device and dragging a progress bar each time a new electronic device is used.

Furthermore, in the embodiment shown in FIG. 1, after Step S103, the control command electronic device may further send a second control information to the second electronic device for controlling the second electronic device to stop playing the media file and turning off its screen. The control command electronic device may send the second control information to the second electronic device after receiving confirmation from the first electronic device that the media file has successfully commenced playback on the first electronic device according to the playback information as this indicates the second electronic device is no longer playing the media file or the user is no longer viewing the media file on the second electronic device. This way, energy consumption is reduced.

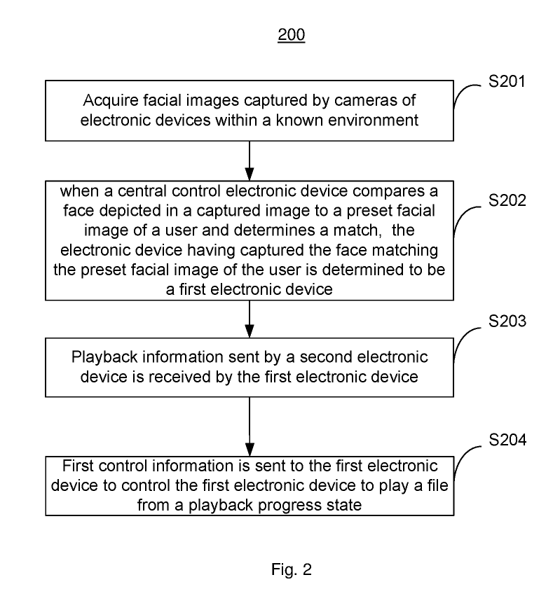

FIG. 2 shows a flow chart 200 describing a process for controlling an electronic device, according to another exemplary embodiment. It may be assumed that the process described by flow chart 200 is implemented within the same known environment as described with reference to flow chart 100.

Step S201: facial images detected by cameras of all electronic devices located at different positions within the known environment may be acquired. The control center device may transmit a facial image acquisition request to the electronic devices within the known environment, thus causing the electronic devices to capture an image depicting a scene within a view of the respective cameras and transmit the captured images to the central control electronic device. In addition or alternatively, the electronic devices located within the known environment may capture images at predetermined timing frequencies, and/or the control center device may receive the facial images at predetermined timing frequencies.

Step S202: when the central control electronic device compares a face depicted in a captured image to a preset facial image of the user and determines a match, the electronic device having captured the face matching the preset facial image of the user is determined to be a first electronic device.

Cameras included on the electronic devices located at different positions within the known environment may capture facial images appearing in their viewing angles upon receipt of a request from the control center device, or at predetermined timing frequencies. The preset facial image of the user is uploaded to the control center device in advance. The control center device acquires the facial images captured by the cameras of ene or more of the electronic devices located at different positions within the known environment. The control center device may acquire the facial images in response to a request for such facial images, or at predetermined timing frequencies. When the facial image captured by the camera of an electronic device and the preset facial image are compared and determined to be a match of the user, the control center device determines the electronic device having captured the matching facial image to be the first electronic device. According to this solution, first electronic device is indicated to be the electronic device the user is in front of and is using to view the media file.

Step S203: playback information sent by a second electronic device is received by the control center device.

Herein, the control center device may facilitates the transmission of playback information from the second electronic device to the first electronic device. The playback information may be sent when the facial image detected by the second electronic device is determined to no longer match with the preset facial image of the user or, when the image captured by the second electronic device is determined to no longer depict any facial images. Either of these situations may be an indication that the user has left the second electronic device, and therefore the second electronic device may be prompted to transmit the playback information to the control center device, which is then received by the control center device.

Step S204: first control information is sent to the first electronic device to control the first electronic device to play the media file from a playback progress state described in the playback information. Herein, the first control information may include: the playback information and screen turning-on control information.

Step S204 is similar to Step S103 in flow chart 100, and will not be elaborated herein.

According to the process for controlling an electronic device provided by the flow chart 200, determination of the first electronic device for handing off the playback of the media file may be improved.

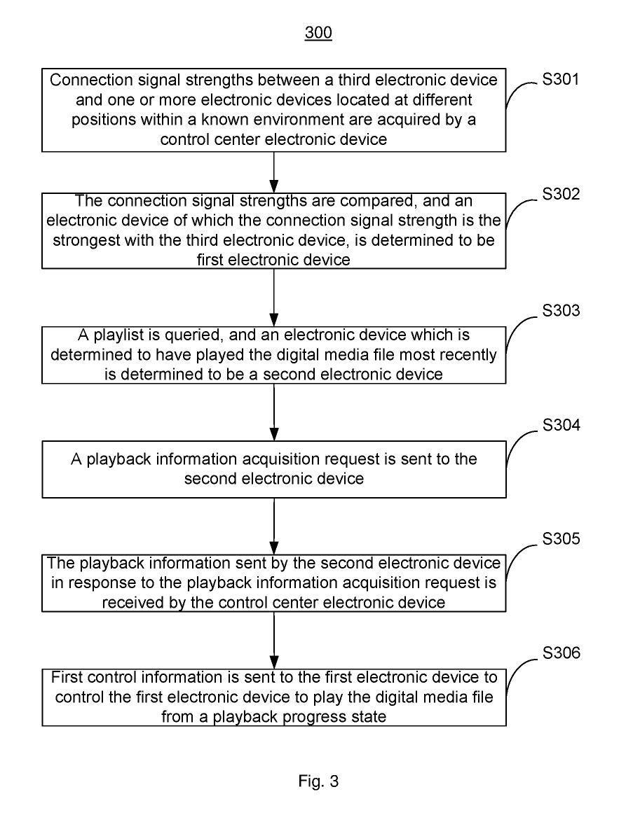

FIG. 3 shows a flow chart 300 describing a process for controlling an electronic device, according to another exemplary embodiment. It may be assumed that the process described by flow chart 300 is implemented within the same known environment as described with reference to flow chart 100.

Step S301: connection signal strengths between a third device and one or more electronic devices located at different positions within the known environment are acquired by the control center device. Herein, the third device may be a wearable type of electronic device worn by the user. The connection signal strength may be referenced to represent a distance between the user and the electronic devices positioned within the known environment.

Step S302: the connection signal strengths are compared, and an electronic device of which the connection signal strength is the strongest with the third device, is determined to be first electronic device.

The third device may be wearable equipment, for example, a wristband. The connection signals may be a Bluetooth signal. The connection signals may exist between the third device and all the electronic devices located at different positions. When the third device is closer to an electronic device, the strength of the connection signal between the third device and the electronic device is stronger. An electronic device, of which the connection signal strength is the strongest with the third device, is determined to be the first electronic device. Since the third device is the device worn by the user, when the strength of the connection signal between the third device and an electronic device is strongest, it is indicated that the user is closest to the electronic device and prepared to watch the electronic device.

Step S303: a playlist may be queried, and an electronic device which is determined to have played the media file most recently (i.e., at a time closest to the current time) may be determined to be the second electronic device.

Herein, the playlist is defined as digital records describing the times of playing media files and the corresponding electronic devices that played them.

For example, the playlist may include an entry describing “time of playing a media file: 13:00; the electronic device which played the media file: tablet.” The playlist may further include an entry describing: “time of playing a media file: 15:00; the electronic device which plays the media file: television.” Now when the current time is 15:13, the television electronic device which played the media file at the 15:00, may be determined to be the second electronic device.

Step S304: a playback information acquisition request is sent to the second electronic device by, for example, the control center device. In response to receiving the playback information acquisition request, the second electronic device may transmit playback information.

Step S305: playback information sent by the second electronic device in response to the playback information acquisition request is received by the control center device.

The control center device sends the playback information acquisition request to the second electronic device. The second electronic device receives the playback information acquisition request sent by the control center, and sends the playback information to the control center device in response to the playback information acquisition request. The control center device receives the playback information sent by the second electronic device in response to the playback information acquisition request.

Step S306: first control information is sent to the first electronic device to control the first electronic device to play the media file from a playback progress state described in the playback information.

Herein, the first control information includes: the playback information and screen turning-on control information.

It is important to note that the playback information may also be determined in a manner adopted in Step S203 in the embodiment.

According to the processes for controlling an electronic device described by the flow chart 300, the first electronic device may be selected based on a connection signal strength representing distance of the user and the first electronic device so that an accuracy is high, and the user experience is further improved.

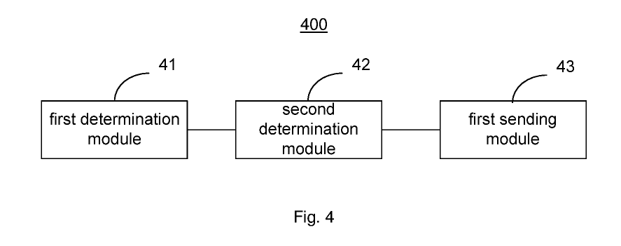

FIG. 4 is a block diagram 400 of an apparatus for controlling an electronic device, according to an exemplary embodiment. As shown in FIG. 4, the apparatus for controlling an electronic device provided by the embodiment includes:

A first determination module 41 configured to determine a first electronic device according to a position of the user, where the first electronic device will receive a hand-off for executing playback of a media file from a playback state on another second electronic device.

A second determination module 42 configured to determine playback information of the media file currently playing on the second electronic device. Herein the playback information may include: an identifier of the media file and a playback progress of the media file.

A first sending module 43 configured to send first control information to the first electronic device to control the first electronic device to play the media file from the playback progress. Herein the first control information may include: the playback information and screen turning-on control information.

The apparatus for controlling an electronic device provided by the embodiment may specifically be configured to execute the process described by the flow chart 100 of the embodiment shown in FIG. 1, and its implementation principle is similar, and will not be elaborated herein.

According to the apparatus for controlling an electronic device described by the block diagram 400, a user's experience viewing the media file as the user moves to different locations and uses different electronic devices may be improved, compared with a manner of manually turning on the electronic device and dragging a progress bar each time a new electronic device is used.

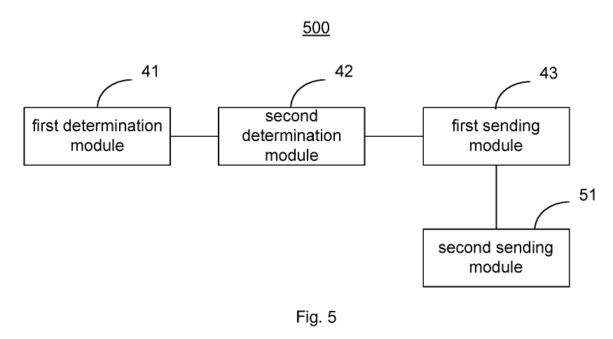

FIG. 5 is a block diagram 500 of an apparatus for controlling an electronic device, according to another exemplary embodiment. As shown in FIG. 5, the apparatus for controlling an electronic device provided by the embodiment, on the basis of the embodiment shown in FIG. 4, further includes:

A second sending module 51 configured to send second control information to the second electronic device to control the second electronic device to stop playing and turn off its screen.

According to the apparatus for controlling an electronic device provided by the embodiment, by the second sending module configured to send the second control information to the second electronic device to control the second electronic device to stop playing and turn off the screen, energy consumption is reduced.

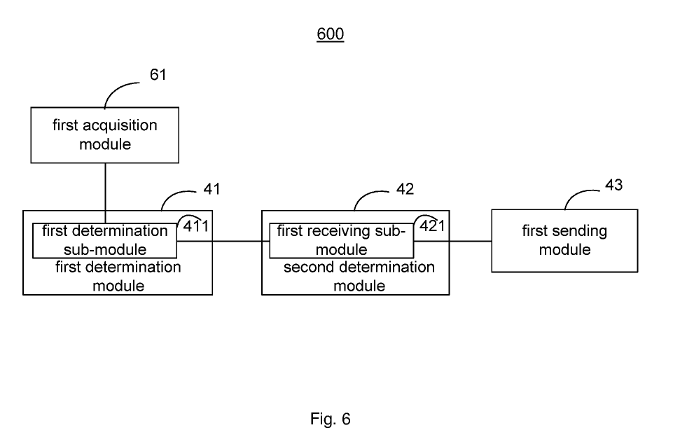

FIG. 6 is a block diagram 600 of an apparatus for controlling an electronic device, according to another exemplary embodiment. As shown in FIG. 6, the apparatus for controlling an electronic device provided by the embodiment, on the basis of the embodiment shown in FIG. 4, further includes:

A first acquisition module 61 configured to acquire facial images captured by cameras of one or more electronic devices located at different positions within a known environment.

The first determination module 41 may include:

A first determination sub-module 411 configured to, when the facial image captured by the camera of an electronic device is determined to match a preset facial image of a user, determine the electronic device having captured the matching facial image to be the first electronic device.

The second determination module 42 may include:

A first receiving sub-module 421 configured to receive the playback information sent by the second electronic device. Herein, the playback information is sent when the facial image captured by the second electronic device is determined not to match the preset facial image of the user, or when images captured by the second electronic device are determined to no longer depict facial images.

The apparatus for controlling an electronic device provided by the embodiment may specifically configured to execute the method of the embodiment shown in FIG. 2, and its implementation principle is similar, and will not be elaborated herein.

According to the apparatus for controlling an electronic device provided by the block diagram 600, determination of the first electronic device for handing off the playback of the media file may be improved.

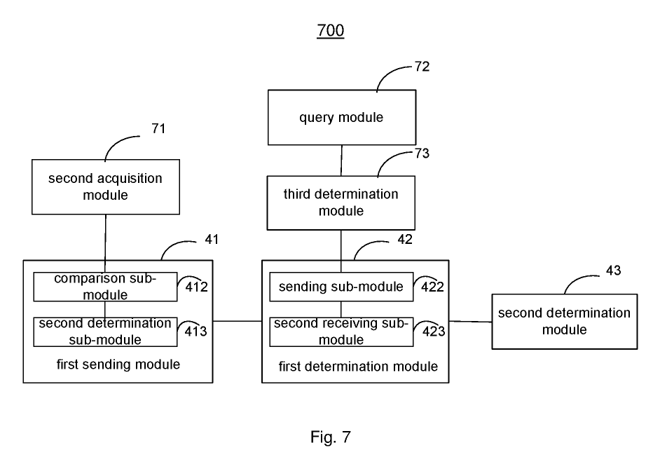

FIG. 7 is a block diagram 700 of an apparatus for controlling an electronic device, according to another exemplary embodiment. As shown in FIG. 7, the apparatus for controlling an electronic device provided by the embodiment, on the basis of the embodiment shown in FIG. 4, further includes:

A second acquisition module 71 configured to acquire connection signal strengths of a third device with one or more electronic devices located at different positions within a known environment.

Herein, the third device is an electronic device worn by the user.

The first determination module 41 includes:

A comparison sub-module 412 configured to compare the connection signal strengths; and a second determination sub-module 413 configured to determine an electronic device, of which the connection signal strength is the strongest with the third device, to be the first electronic device.

A query module 72 is configured to query a playlist.

A third determination module 73 is configured to determine the electronic device which plays the media file at time closest to current time to be the second electronic device.

Herein, the playlist records corresponding relationship between times of playing media files and electronic devices which play media files.

The second determination module 42 includes:

a sending sub-module 422 configured to send a playback information acquisition request to the second electronic device; and a second receiving sub-module 423 configured to receive the playback information sent by the second electronic device in response to the playback information acquisition request.

In an implementation mode, the third device is a wristband, and the connection signals are Bluetooth signals.

The apparatus for controlling an electronic device provided by the embodiment may specifically be configured to execute the method of the embodiment shown in FIG. 3, and an implementation principle is similar, and will not be elaborated herein.

According to the apparatus for controlling an electronic device provided by the block diagram 700, the first electronic device may be selected based on a connection signal strength representing distance of the user and the first electronic device so that an accuracy is high, and the user experience is further improved.

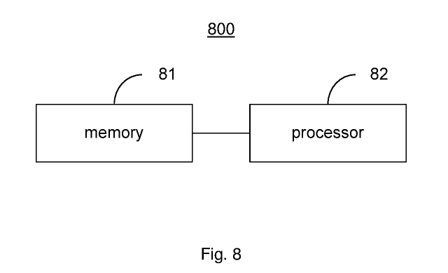

FIG. 8 is a block diagram 800 of an apparatus for controlling an electronic device, according to an exemplary embodiment. As shown in FIG. 8, the apparatus for controlling an electronic device provided by the embodiment includes:

A processor 82; and a memory for storing instructions executable by the processor 82. The processor 82 may be configured to execute the instructions to: determine a first electronic device according to a position of the user; determine playback information of a media file currently played by a second electronic device, wherein the playback information includes: an identifier of the media file and a playback progress of the media file; and send first control information to the first electronic device to control the first electronic device to play the media file from the playback progress state described by the playback information, wherein the first control information includes: the playback information and screen turning-on control information.

According to the apparatus for controlling an electronic device provided by the block diagram 800, hand off of playing a media file is improved compared with a manner of manually turning on the electronic device and dragging a progress bar by the user.

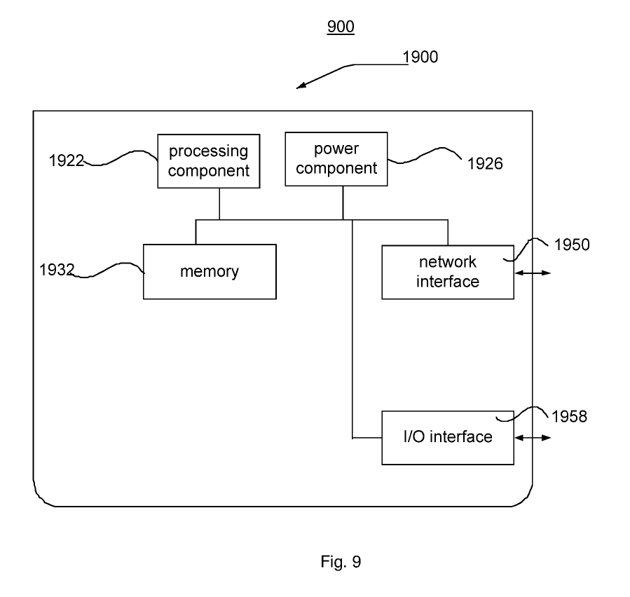

FIG. 9 is a block diagram 900 of an apparatus for controlling an electronic device, according to an exemplary embodiment. For example, the apparatus 1900 may be provided as a server. Referring to FIG. 9, the apparatus 1900 includes a processing component 1922, which further includes one or more processors, and a memory resource represented by a memory 1932 configured to store instructions such as application programs executable for the processing component 1922, herein the memory 1932 may include nonvolatile computer-readable storage medium and/or volatile computer-readable storage medium. The application programs stored in the memory 1932 may include one or more than one module of which each corresponds to a set of instructions. In addition, the processing component 1922 is configured to execute the instructions to execute the abovementioned methods including that: the first electronic device to be watched by the user is determined according to the position of the user; the playback information of the media file currently played by the second electronic device is determined, herein the playback information includes: the identifier of the media file and the playback progress of the media file; and the first control information is sent to the first electronic device to control the first electronic device to play the media file from the playback progress, herein the first control information includes: the playback information and the screen turning-on control information.

The apparatus 1900 may further include a power component 1926 configured to execute power management of the apparatus 1900, a wired or wireless network interface 1950 configured to connect the apparatus 1900 to a network, and an Input/Output (I/O) interface 1958. The apparatus 1900 may be operated on the basis of an operating system stored in the memory 1932, such as Windows Server™, Mac OS X™, Unix™, Linux™ or FreeBSD™.

Each module, submodule, or unit discussed above for FIGS. 4-7, may take the form of a packaged functional hardware unit designed for use with other components, a portion of a program code (e.g., software or firmware) executable by the processor 82, processing component 1922, or the processing circuitry that usually performs a particular function of related functions, or a self-contained hardware or software component that interfaces with a larger system, for example.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

### INDUSTRIAL APPLICABILITY

In an embodiment of the disclosure, by determining the first electronic device to be watched by the user according to the position of the user, determining the playback information of the media file currently played by the second electronic device, the playback information including: the identifier of the media file and the playback progress of the media file, and sending the first control information to the first electronic device to control the first electronic device to play the media file from the playback progress, the first control information including: the playback information and the screen turning-on control information, the first electronic device to be watched by the user may be automatically determined according to the position of the user, a screen of the first electronic device to be watched may be controlled to be turned on and the playback information of the media file currently played by the second electronic device may be sent to the first electronic device, so that determination of the electronic device to be watched by the user according to the position of the user is implemented, playing of the media file from the playback progress state is also implemented, and compared with a manner of manually turning on the electronic device and dragging a progress bar by the user, such a manner improves a user experience.

In another embodiment, by acquiring the facial images detected by the cameras of all the electronic devices located at different positions, if the facial image detected by the camera of an electronic device and the preset facial image are facial images of the same user, determining the electronic device to be the first electronic device, receiving the playback information sent by the second electronic device, the playback information being sent when the facial image detected by the second electronic device and the preset facial image are not facial images of the same user, or, the playback information being sent when the second electronic device does not detect any facial image, and sending the first control information to the first electronic device to control the first electronic device to play the media file from the playback progress state, the first electronic device to be watched by the user may be determined according to whether the facial image detected by the camera of the electronic device and the preset facial image are facial images of the same user or not when being determined according to the position of the user, the playback information sent by the second electronic device is received, and a first electronic device determination process and the playback information have high accuracy, so that the user experience is further improved.

In another embodiment, by acquiring the connecting signal strengths of each of all electronic devices located at different positions with the third device respectively, comparing the connecting signal strengths, determining an electronic device, of which the connecting signal strength is the strongest with the third device, to be the first electronic device, querying the playlist, determining the electronic device which plays the media file at the time closest to the current time to be the second electronic device, sending the playback information acquisition request to the second electronic device, receiving the playback information sent by the second electronic device in response to the playback information acquisition request, and sending the first control information to the first electronic device to control the first electronic device to play the media file from the playback progress state, an electronic device, of which the connecting signal strength is the strongest with the third device, may be determined to be the first electronic device according to the connecting signal strengths, and accuracy is high, so that the user experience is further improved.

What is claimed is:

1. A method for controlling an electronic device, comprising:
identifying a second electronic device playing a media file;
determining a position of a user;
determining a first electronic device for receiving a playback hand off of the media file according to the position of the user;
determining playback information of the media file, wherein the playback information comprises an identifier of the media file and a playback progress of the media file; and
transmitting first control information to the first electronic device, wherein the first control information comprises the playback information and screen activation control information.

2. The method according to claim 1, further comprising:
transmitting second control information to the second electronic device to control the second electronic device to stop playing the media file and deactivate a display screen of the second electronic device.

3. The method according to claim 1, further comprising:
acquiring facial images captured by cameras of a plurality of electronic devices located at different positions within a predetermined environment;
wherein determining the first electronic device according to the position of the user comprises:
when a facial image captured by a camera of one of the plurality of electronic devices is determined to match a preset facial image of the user, selecting the one of the plurality of electronic devices as the first electronic device for receiving the playback handoff of the media file.

4. The method according to claim 3, wherein determining the playback information of the media file comprises:
receiving the playback information from the second electronic device, wherein the playback information is sent by the second electronic device when the facial image captured by the second electronic device is determined not to match a preset facial image of the user, or when facial images captured by the second electronic device are no longer determined to depict any facial features.

5. The method according to claim 1, further comprising:
acquiring connection signal strengths that a plurality of electronics devices located at different positions within a predetermined environment respectively have with a third device, wherein the plurality of electronic devices includes the first electronic device and wherein the third device is a device worn by the user;
wherein determining the first electronic device according to the position of the user comprises:
comparing the acquired connection signal strengths, and determining the first electronic device for receiving the playback hand off of the media file based on the first electronic device having the strongest connection signal strength with the third device.

6. The method according to claim 5, wherein the third device is a wristband, and the connection signals are Bluetooth signals.

7. The method according to claim 1, further comprising:
querying a playlist, and determining an electronic device which most recently played the media file as the second electronic device based on the query, wherein the playlist describes times of playing media files by respective electronic devices,
wherein determining the playback information of the media file comprises:
sending a playback information acquisition request to the second electronic device; and
receiving the playback information sent by the second electronic device in response to the playback information acquisition request.

8. An apparatus for controlling an electronic device, comprising:
a processor; and
a memory configured to store instructions executable by the processor,
wherein the processor is configured to execute the instructions to:
identify a second electronic device playing a media file;
determine a position of a user;
determine a first electronic device for receiving a playback hand off of the media file according to the position of the user;
determine playback information of a media file, wherein the playback information comprises: an identifier of the media file and a playback progress of the media file; and
transmit first control information to the first electronic device, wherein the first control information comprises: the playback information and screen activation control information.

9. The apparatus according to claim 8, wherein the processor is further configured to execute the instructions to, transmit second control information to the second electronic device to control the second electronic device to stop playing the media file and deactivate a display screen of the second electronic device.

10. The apparatus according to claim 8, wherein the processor is further configured to execute the instructions to:
acquire facial images captured by cameras of a plurality of electronic devices located at different positions within a predetermined environment;
wherein in order to determine the first electronic device according to the position of the user, the processor is configured to:
when a facial image captured by the camera of the first electronic device is determined to match a preset facial image of the user, determine the first electronic device for receiving the playback hand off of the media file.

11. The apparatus according to claim 10, wherein in order to determine the playing information of the media file currently played by the second electronic device, the processor is configured to:
receive the playing information sent by the second electronic device, wherein the playing information is sent when the facial image detected by the second electronic device and the preset facial image are not facial images of the same user, or, the playing information is sent when the second electronic device does not detect any facial image.

12. The apparatus according to claim 8, wherein the processor is further configured to execute the instructions to:
acquire connection signal strengths that a plurality of electronics devices located at different positions within a predetermined environment respectively have with a third device, wherein the plurality of electronic devices includes the first electronic device and wherein the third device is a device worn by the user;
wherein determining the first electronic device according to the position of the user comprises:
compare the acquired connection signal strengths, and determining the first electronic device for receiving the playback hand off of the media file based on the first electronic device having the strongest connection signal strength with the third device

13. The apparatus according to claim 12, wherein the third device is a wristband, and the connection signals are Bluetooth signals.

14. The apparatus according to claim 8, wherein the processor is further configured to execute the instructions to:
query a playlist, and determining an electronic device which most recently played the media file as the second electronic device based on the query, wherein the playlist describes times of playing media files by respective electronic devices,
wherein in order to determine the playing information of the file currently played by the second electronic device, the processor is configured to:
send a playback information acquisition request to the second electronic device; and
receiving the playback information sent by the second electronic device in response to the playback information acquisition request.

15. A non-transitory computer-readable storage medium having stored therein instructions that, when executed by a processor, causes the processor to:
identifying a second electronic device playing a media file;
determining a position of a user;
determining a first electronic device for receiving a playback hand off of the media file according to the position of the user;
determining playback information of a media file, wherein the playback information comprises: an identifier of the media file and a playback progress of the media file; and
transmitting first control information to the first electronic device, wherein the first control information comprises: the playback information and screen activation control information.

16. The non-transitory computer-readable storage medium according to claim 15, further comprising instructions for:
transmitting second control information to the second electronic device to control the second electronic device to stop playing the media file and deactivate a display screen of the second electronic device.

17. The non-transitory computer-readable storage medium according to claim 15, further comprising instructions for:
acquiring facial images captured by cameras of a plurality of electronic devices located at different positions within a predetermined environment;
wherein determining the first electronic device according to the position of the user comprises:
when a facial image captured by the camera of the first electronic device is determined to match a preset facial image of the user, determining the first electronic device for receiving the playback hand off of the media file.

18. The non-transitory computer-readable storage medium according to claim 17, wherein determining the playing information of the media file currently played by the second electronic device comprises:
receiving the playback information from the second electronic device, wherein the playing information is sent by the second electronic device when the facial image captured by the second electronic device is determined not to match a preset facial image of the user, or when facial images captured by the second electronic device are no longer determined to depict any facial features.

19. The non-transitory computer-readable storage medium according to claim 15, further comprising instructions for:
acquiring connection signal strengths that a plurality of electronics devices located at different positions within a predetermined environment respectively have with a third device, wherein the plurality of electronic devices includes the first electronic device and wherein the third device is a device worn by the user;
wherein determining the first electronic device according to the position of the user comprises:
comparing the acquired connection signal strengths, and determining the first electronic device for receiving the playback hand off of the media file based on the first electronic device having the strongest connection signal strength with the third device.

20. The non-transitory computer-readable storage medium according to claim 15, further comprising instructions for:
querying a playlist, and determining an electronic device which most recently played the media file as the second electronic device based on the query, wherein the playlist describes times of playing media files by respective electronic devices,
wherein determining the playback information of the media file comprises:
sending a playback information acquisition request to the second electronic device; and
receiving the playback information sent by the second electronic device in response to the playback information acquisition request.
